(19) United States
(12) Patent Application Publication
(10) Pub. No.: US 2013/0006804 A1
(43) Pub. Date: Jan. 3, 2013

(54) WEB BASED SYSTEM AND METHOD FOR REVERSE TRADING TRANSACTIONS

(76) Inventor: Shahin Khani, Pleasant Hill, CA (US)

(21) Appl. No.: 13/536,910

(22) Filed: Jun. 28, 2012

Related U.S. Application Data
(60) Provisional application No. 61/502,295, filed on Jun. 28, 2011.

(51) Int. Cl. G06Q 30/06

(52) U.S. Cl. 705/26.8

(57) ABSTRACT

An internet server or web server based trading system that is designed to facilitate barter type trade transactions. In addition to accommodating standard type trade searches that allows users to browse for items or services that the user wants or needs, the system also has a unique reverse trading system, here called “Wishtrades”, that also allows a user to enter in what the user has, and receive a list of items or services that can be traded for what the user has. The invention also has additional features, such as integration with social networks and geographic proximity based searching to improve reliability, as well as various automatic search features designed to allow the system to continually look for potential beneficial trades when the user is not online, and to notify the user when such trades are detected.

### CROSS REFERENCE TO RELATED APPLICATIONS

This invention claims the priority benefit of provisional application 61/502,295 entitled “WEB BASED SYSTEM AND METHOD FOR REVERSE TRADING TRANSACTIONS”, inventor Shahin Khani, filed Jun. 28, 2011; the contents which are incorporated herein by reference.

### BACKGROUND OF THE INVENTION

1. Field of the Invention

This invention is in the field of barter based ecommerce transactions.

2. Description of the Related Art

Barter, which is the direct exchange of items (i.e. services and goods) without the use of money, has likely been used in commerce for tens of thousands of years or more. With the advent of the Internet and web server/web browser methods of ecommerce, various websites now also feature various barter methods as well.

For example, Craig's list has a barter section which enables users to make posts that contain a description of the articles that they have, along with a specific item that they are looking for. A typical example might be a proposal to exchange outdoor cement stepping stones for gravel, or an offer to provide firewood in exchange for yard services, and so on.

However these prior art web-based barter systems have problems with inefficiency and reliability. In order to accomplish a successful barter transaction, often many email transactions have to take place with users that may have an item of interest, but who may not be interested in a particular proposed trade. Potential fraud—that is the potential for trading for items that may have undocumented defects, is also a problem. Thus further improvements in ecommerce bartering methods would be desirable.

### BRIEF SUMMARY OF THE INVENTION

The invention is based, in part, on the insight that although individuals often can form very definite opinions as to the particular items or services that they have that they are willing to put up for barter, often such individuals may have difficulty stating the full range of things (other than money) that they might be willing to consider trading for. Thus methods that provide a person wishing to barter an item with a fuller list of possible barter options would be desirable.

The invention is also based, in part on the insight that many items being bartered are used items, and many services that are being bartered may be non-expert services. Thus many bartered items and services may have hidden defects. This creates an opportunity for less than fully honest individuals to “game” the system by participating in trades that may not be fully satisfactory. Thus methods that encourage greater reliability in trade-type transactions would also be desirable.

The invention is also based, in part on the insight that individuals have different types of search needs. On the one hand, at times individuals may wish to make an immediate online search for a trade of interest without having to do much more than type in a key word. On the other hand, often individuals are willing to enter in additional data, and also wait for longer periods of time for a response, in order to realize the potential of a particular trade.

The present invention may be an internet web server based trading system that is designed to facilitate barter type trade transactions. In addition to accommodating standard type trade searches that allows users to browse for items or services that the user wants or needs, the system also has a unique reverse trading system, here called “Wishtrades”, that also allows a user to enter in what the user has, and receive a list of items or services that can be traded for what the user has. The invention also has additional features, such as integration with social networks and geographic proximity based searching to improve reliability, as well as various automatic search features designed to allow the system to continually look for potential beneficial trades when the user is not online, and to notify the user when such trades are detected.

### BRIEF DESCRIPTION OF THE DRAWINGS

FIG. 1 shows an example of how a prior art trading system might operate between three different individuals, illustrating some of the problems with prior art systems such as inefficiency.

FIG. 2 illustrates another example of prior art trading systems, illustrating some of the reliability problems associated with these systems.

FIG. 3 shows the improved data structures of the present invention, which enable individuals to receive a list of items or services that can be traded for what the user has.

FIG. 4 shows the improved system of FIG. 4, additionally configured to run automatically (i.e. to perform a standing search for items of potential interest to the user).

FIG. 5 shows an example of a web server based ecommerce system.

FIG. 6 shows the homepage of the system in the normal trading mode.

FIG. 7 shows the homepage of the system in wishtrade trading mode.

FIG. 8 shows an iphone version of the homepage in the normal trading mode.

FIG. 9 shows an iphone version of the homepage in the wishtrade trading mode.

FIG. 10 shows an item description page.

FIG. 11 shows a messages page.

FIG. 12 shows a posts page.

FIG. 13 shows a page for creating a new posting.

FIG. 14 shows a user registration page.

FIG. 15 shows a searching for possible trades result page.

FIG. 16 shows a search for possible wishtrades result page.

FIG. 17 shows a sending messages page.

### DETAILED DESCRIPTION OF THE INVENTION

In one embodiment, the invention may be a web-based ecommerce reverse trading method. Here, instead of entering in a list of items or services that a user wishes to obtain, the user enters in a list of items or services that the user has. The system automatically matches up this list of items that the user has with a list of items wanted by other users, and automatically generates a list of possible trades. To improve reliability, the system can give more weight to users that are closer each other locally. The system can also link to one or more social networks, such as Facebook or Twitter, and give more weight to recommending potential trades between users with a higher degree of social connectivity. The system can optionally also automatically conduct searches for items and/or services that are linked to the individual user, rather than to the user's particular set of trade items, and automatically inform the user of matches of interest by email, SMS, or other methods. The system may also perform more conventional direct trade transactions as well.

Note that although for brevity, in general the specification will refer to a web server and a web browser, in actuality the invention may be construed more broadly. Thus for example, any type of internet server may be used as the server, including internet servers that do not serve web pages. Similarly although web browsers will often be used as an example, in some embodiments, such as when mobile smartphones or tablet computers and the like are used, various mobile apps (e.g. applications software) which may not fully function as standard web browsers may also be used.

The web servers or other internet servers and other computerized devices disclosed herein will generally comprise at least one processor (often a microprocessor exemplified by the popular x86, ARM, MIPS family of microprocessors), with one or more cores per processor. The servers and other computerized devices will also comprise memory such as RAM, ROM, Flash, disk drives, and the like, software (e.g. operating system software such as Windows, Linux, Unix, iOS, Android and the like), and applications software. Generally the functionality disclosed herein will be implemented by applications software running on the various servers and other types of computerized devices.

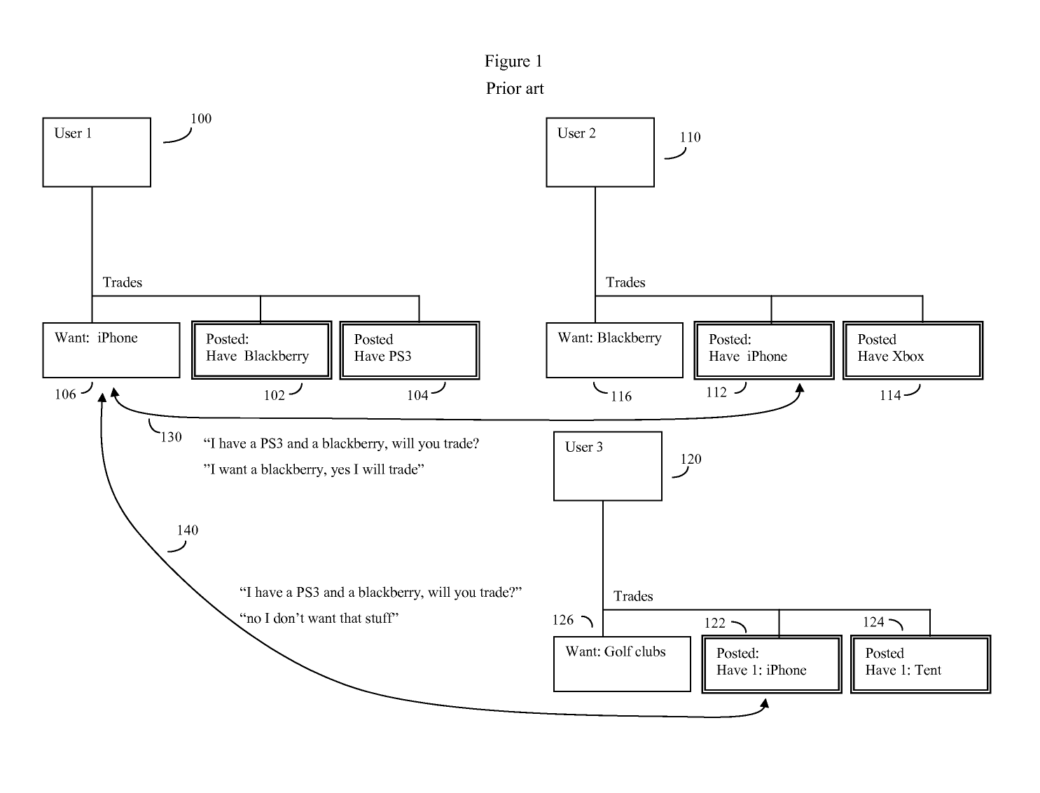

FIG. 1 shows an example of how a prior art online (web-based) trading system, such as the Craig's list barter system, might operate between three different individuals, illustrating some of the problems with prior art systems such as inefficiency. Here user 1 (100) may post that he or she has various items for barter, such as a Blackberry (102) and a Sony Playstation 3 (104), and this person may also manually enter into a web browser connected to the system's server that he or she is looking for an iPhone (106). Another user, user 2 (110) using the system's database might post that he or she has an iphone (112) and other items such as an Xbox (114), and user 2 may manually search for something else such as a Blackberry portable phone (116). A third user, user 3 (120) using the online database might also post that they have an iphone (122), and possibly other items such as a Tent (124), and they in turn may want to search for something else like golf clubs (126).

One problem with this prior art approach is that it is inefficient. For example when user (100) searches for an iPhone (106), in this example two different matches will be proposed. These matches will be user 2 (112) and user 3 (122). However user 1 has no way of knowing if user 2 or user 3 is interested in trading for what user 1 has to offer. As a result, user 1 (100) will typically have to email both user 2 (130) and user 3 (140) and have dialogs such as: “I see you have an iPhone, I have a PS3 and a Blackberry, want to trade?” In response to any given proposed barter transaction, which some users, such as user 2 might agree “I want a blackberry, yes I will trade” (130), but often other users might respond in the negative such as “No, I don't want that stuff” (140). Since on the average, most other users will not be interested in any given barter transaction trade, user 3's response (140) is likely to be typical, resulting in much wasted time and effort following up on false leads.

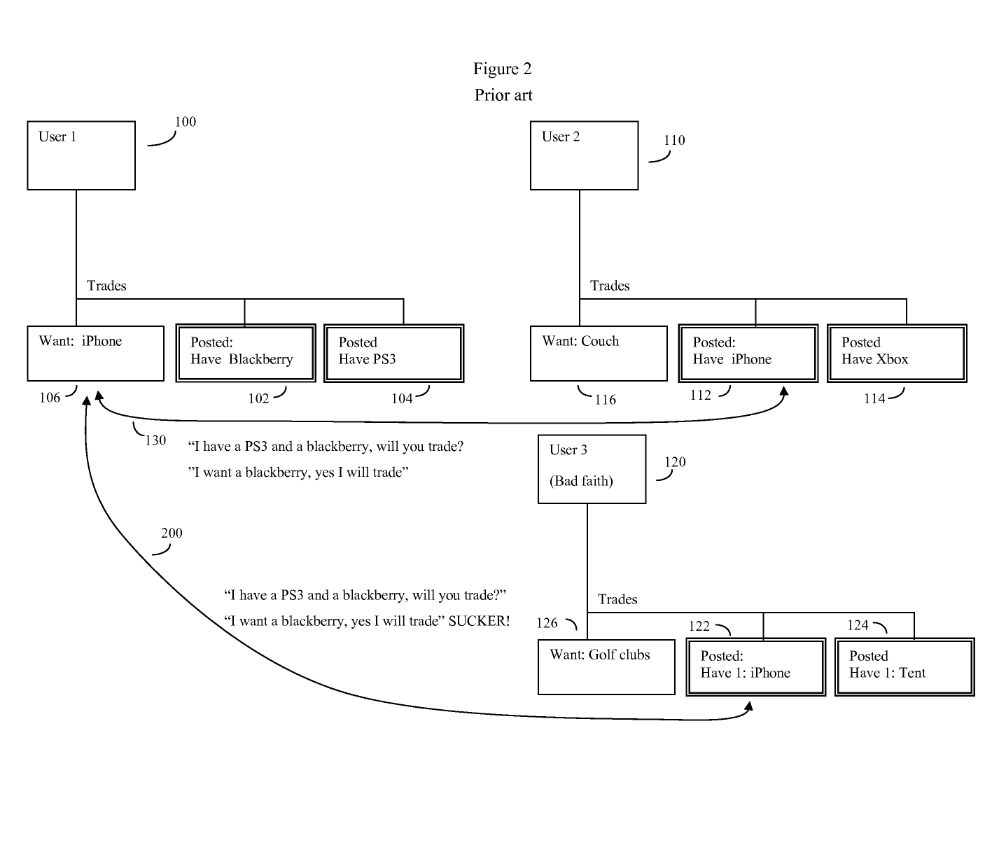

FIG. 2 illustrates another example of prior art trading systems, illustrating some of the reliability problems associated with these systems. In FIG. 2, the situation is almost exactly the same as FIG. 1, except that user 3 (120) is now a bad faith user. Here user 3 may attempt to take advantage of the ambiguity and lack of quality control associated with trading, and may try to abuse the trade by either providing a defective iphone or perhaps, if the transaction is long distance, by not providing anything in return at all (200).

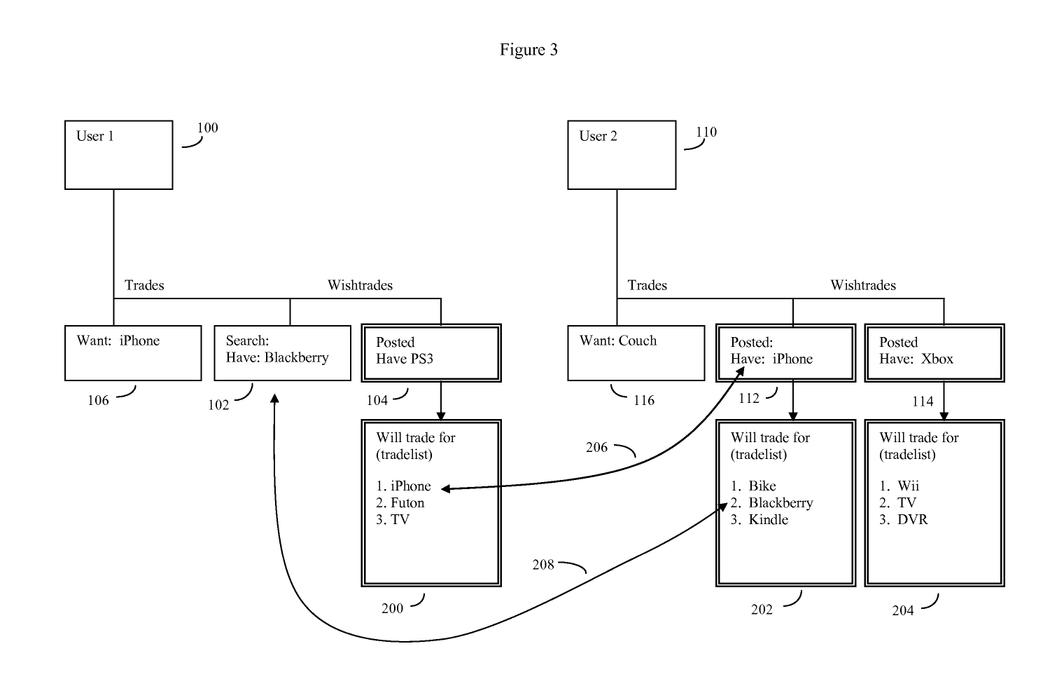

FIG. 3 shows the improved data structures of the present invention, which enable individuals to receive a list of items or services that can be traded for what the user has.

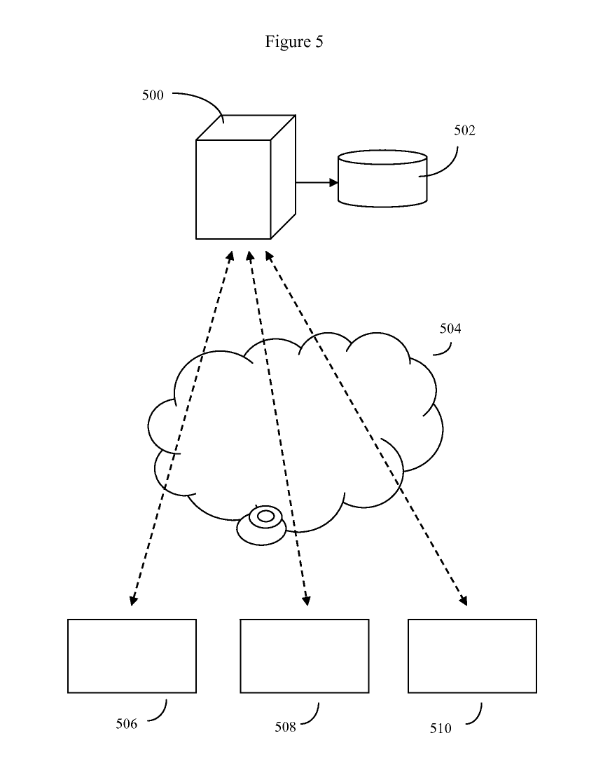

Here the invention provides a system (e.g. a web-server/database system FIG. 5 500, 502) and a method of facilitating the trading of a first possessed set of goods and/or services (e.g. a blackberry 102) for a second wanted set of goods and/or services (e.g. an iPhone (112).

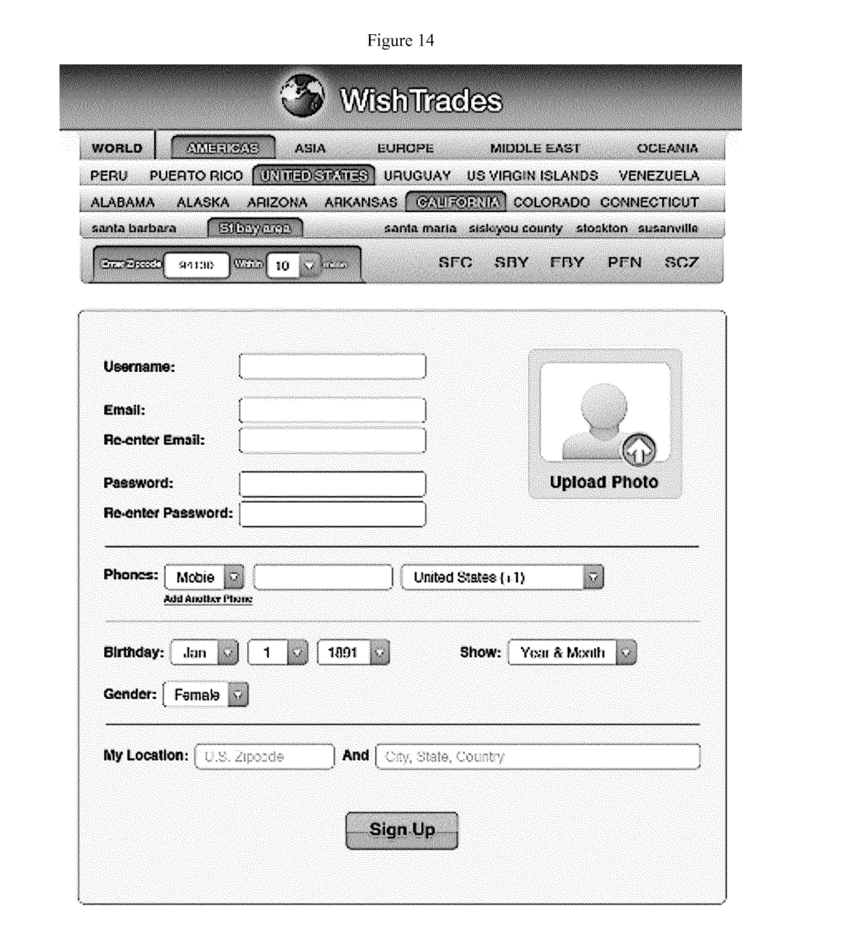

This method will generally comprise or operate by creating a plurality of computer database listings for a plurality of users (e.g. 100, 110, and 120). This computer database (502) will generally be linked to a web server (see FIG. 5 500). Each computer database listing will generally comprise at least a user identification field (e.g. data identifying users 100, 110, 120, see also FIG. 14), a possessed item field that describes a possessed set of goods and/or services belonging to the user (e.g. 102, 104, 112, 114), as well as one or more additional item wanted fields (200, 202, 204) that describe an additional set of wanted goods and/or services, not presently, belonging to the user, that the user wants, and the user will willingly give the possessed set of goods and/or services (102, 104, 112) to obtain them.

According to the method, a user (110) will generally use a least one web browser on a computerized device (e.g. Smartphone such as an iPhone, tablet, laptop computer, and the like 506, 508, 510) connected to the web server (500) by a network connection (e.g. an internet connection 504) to enter in a first possessed set of goods and/or services (102) as a search criteria to search the one or more additional wanted fields (202), (204) that describe this additional set of wanted goods and/or services, such as the goods and services desired by user 2 (110).

Here for example, if user 1 tells the system that he has a blackberry (102), the system will use the term “blackberry” as a term to search the database (502) for the other user's wanted fields (202), (204), and the system will find (208) that wanted field (202) of user 2 (110) contains a match.

The system can then return a result list to user 1's web browser (100), (506) giving at least some of the user identification fields corresponding to user 2 (110) (508) who had previously entered additional wanted fields (202) that correspond to user 2's first possessed set of goods and/or services (112). This returned list will comprise a second wanted list of goods and services, that is, it will confirm that user 2 (110) wants a Blackberry (202) (208).

The system will then usually allow user 1 (100) to establish communication with user 2 (110). That is, it will enable internet or other type communication (e.g. phone, SMS message, email, etc) between at least some of those users that have the first possessed set of goods and/or services (102) and those users (110) with additional wanted fields (202) that correspond to this first possessed set of goods and/or services.

Here the main advantage over prior art is that now user 1 knows for sure that user 2 is interested in, for example, a Blackberry for iPhone swap, and the much wasted effort with uninterested users, previously shown in FIG. 1, can now be avoided.

Note also that alternatively, user 2, although perhaps not actively searching user 1's blackberry (102), may also automatically receive notice back from the system then the system detects (206) that user 1's tradelist (200) contains an iPhone, and user 2 posts that he or she has an iPhone (112). This helps the system act in a semi-automatic manner, and keep on the lookout for the best trades for the users even when neither user may be online.

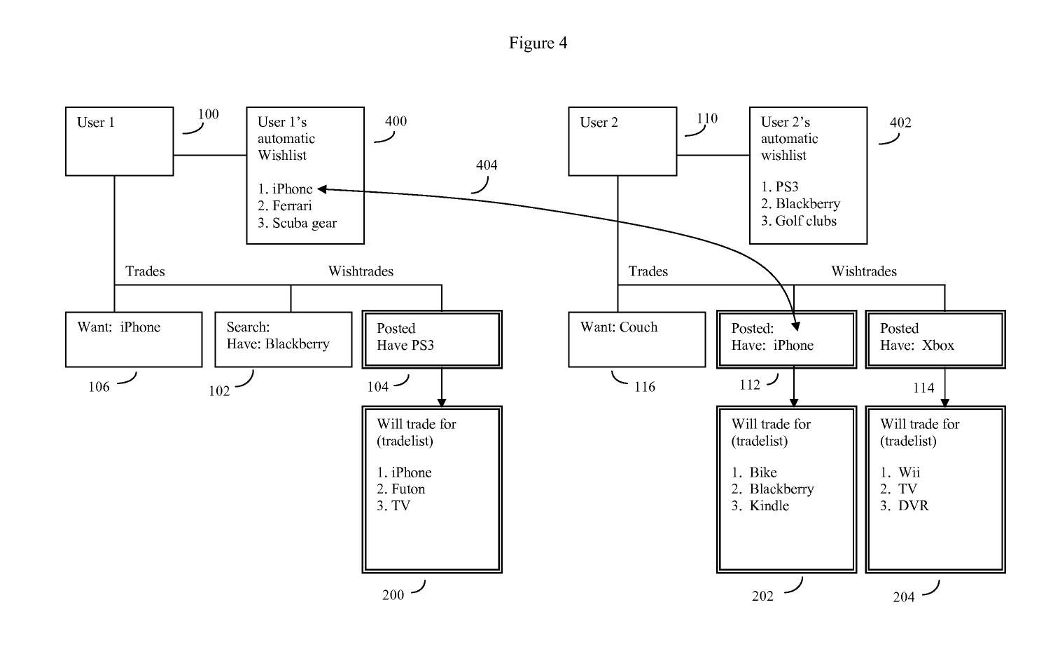

FIG. 4 shows the invention in an optional embodiment where the system is also additionally configured to run automatically (i.e. to perform a standing search for items of potential interest to the user). In this embodiment, in addition to posting tradelists (200), (202), (204) that are associated with each item that the users post (e.g. 104, 112, 114), the system database is also configured to also have a standing “wishlist” (400), (402) of a wanted set of goods and/or services that is directly associated with at least some of the users (e.g. 100, 110) rather than the user's posted items (104, 112, 114). With this optional wishlist feature, the system may be configured to search the database (502) for the first possessed set of goods and services (104), (112), (114), and automatically transmit to the particular wishlist user (e.g. 100) a list of at least some of those users (110) that have first possessed set of goods and services (112) that matches the standing list (400) to the users associated with the wishlist (100). When this happens, the system can, for example, send an email to user 1 (100) letting him or her know about this potential match (404).

FIG. 5 shows an example of the hardware, software and network environment of the invention. Often the invention will consist of software that is running on a standard a web server (500) and associated database (502). Users will connect to the server over a network such as the Internet (504) (which may include cell phone or other wireless links), often using web browsers running on various computerized devices (506, 508, 510) such as smartphones, laptop computers, tablet computers and the like.

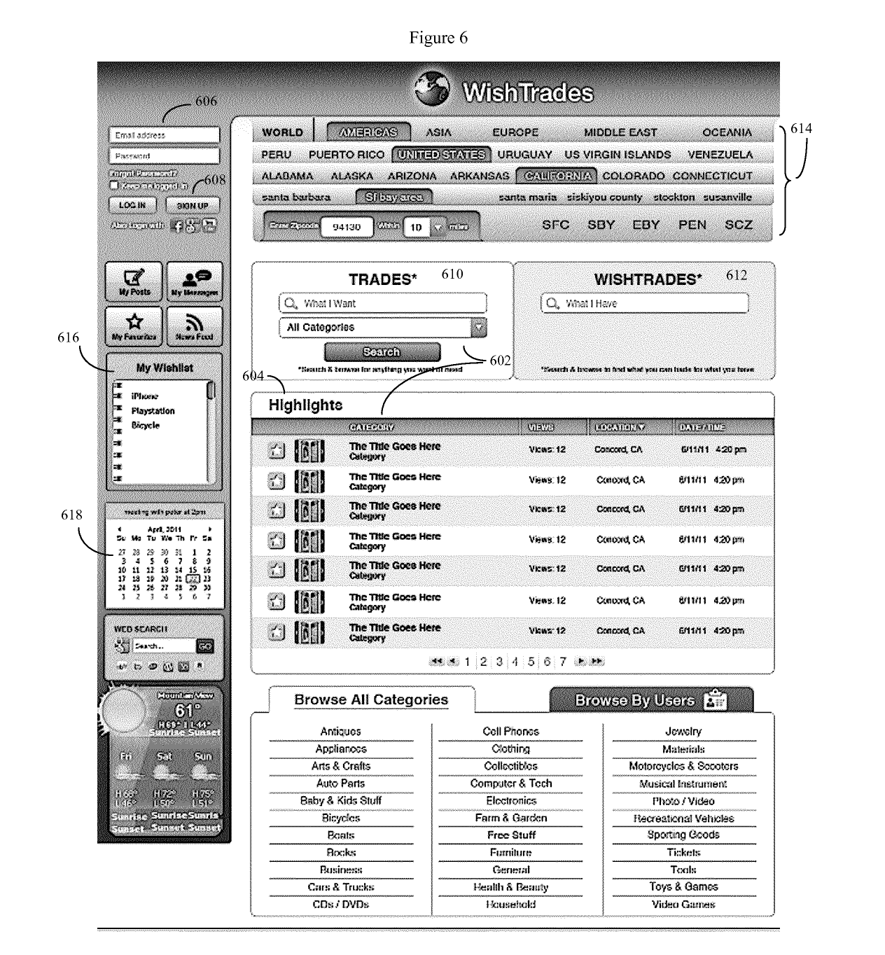

FIG. 6 shows the web browser homepage delivered by server (500) to various computerized devices (506, 508, and 510) showing one embodiment the system in the normal trading mode. Here the trades section (602) is where the user does a fairly conventional type barter search for what he or she wants. In this embodiment, the system also has a highlights section (104) which may list the most recent or interesting system posts. Here users may log into the system at (106), and new users may sign up at (608). Section (608), for example, may lead to a sign up page, one example of which is shown in more detail in FIG. 14.

The system also may have a posts page, and a message page, which may be similar to other social network message pages such as a Facebook message page.

In the embodiment shown in these mockup screenshots, the system is set up to make it easy for the user to switch between the more conventional search for trades section (610), and the invention's novel wishtrade method (612), simply by clicking a mouse. In FIG. 6, the conventional trade section (610) is activated. FIG. 6 also shows various sections to facilitate geographical localization of the user (614).

The optional wishlist section is shown in (616). Other features, such as a meeting calendar to schedule trades (618), various buttons for posting on social networks, creating RSS news feeds of the trade results, emailing, and the like, may also be provided (620).

Thus if the user selects the trade section (610), the search buttons and interfaces may be located are on the trade side, while if the user searches the wishtrade section, then the search buttons and interfaces may be located on the wishtrade side (612). The search results below (presently occupied by the Highlights section 604) will also vary accordingly.

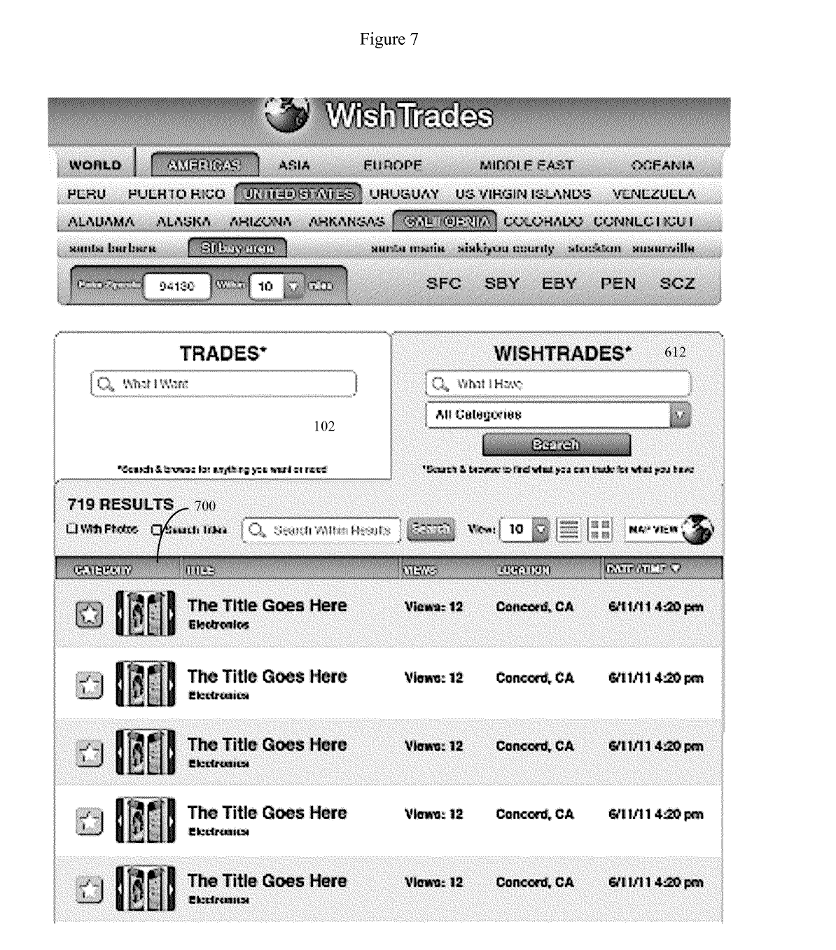

FIG. 7 shows the homepage of the system in wishtrade trading mode. As can be seen, the search button and interface is now on the wishtrade section (612), and the wishtrade results would go below in section (700). Note that in this example, this section lets you search by category, title, and user interest (e.g. how many views in that item), where the item is located, and when the item was posted.

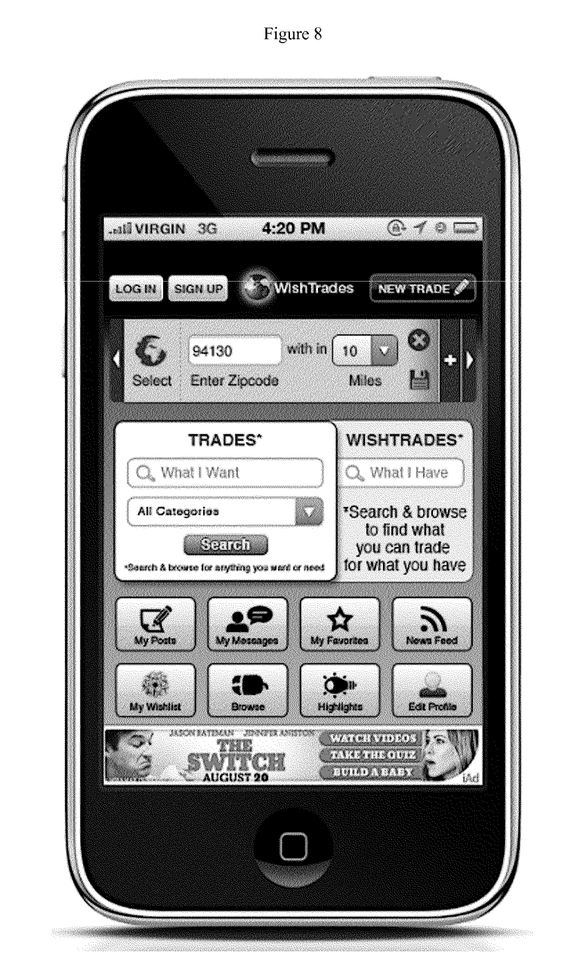

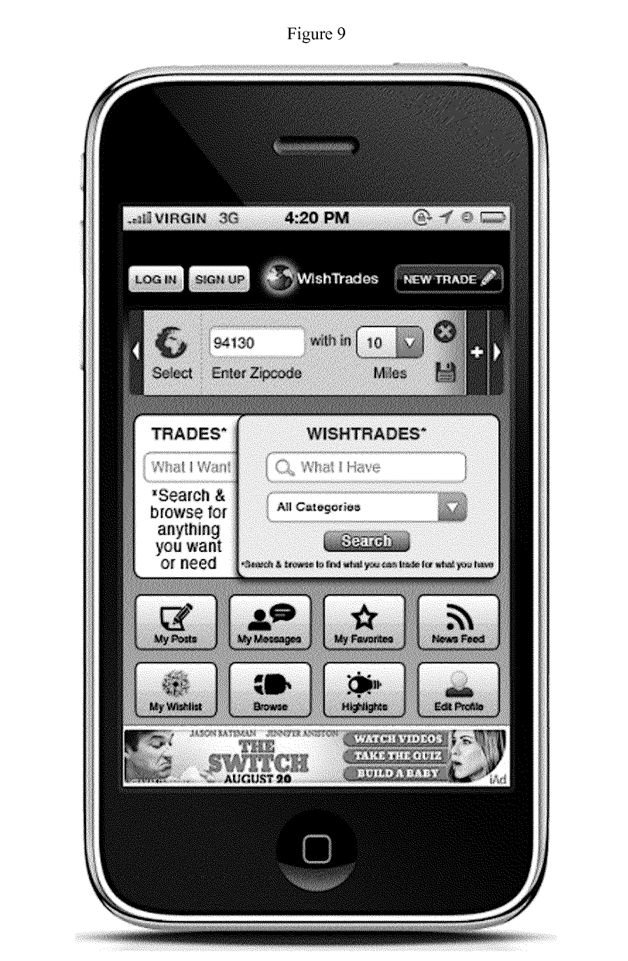

Often, users may wish to use the system from mobile devices such as smartphones. To accommodate this wish, server (500) and database (502) may send out alternate web pages configured for smaller screen devices. Here FIG. 8 shows an iphone version of the homepage in the normal trading mode, while FIG. 9 shows an iphone version of the homepage in the wishtrade trading mode.

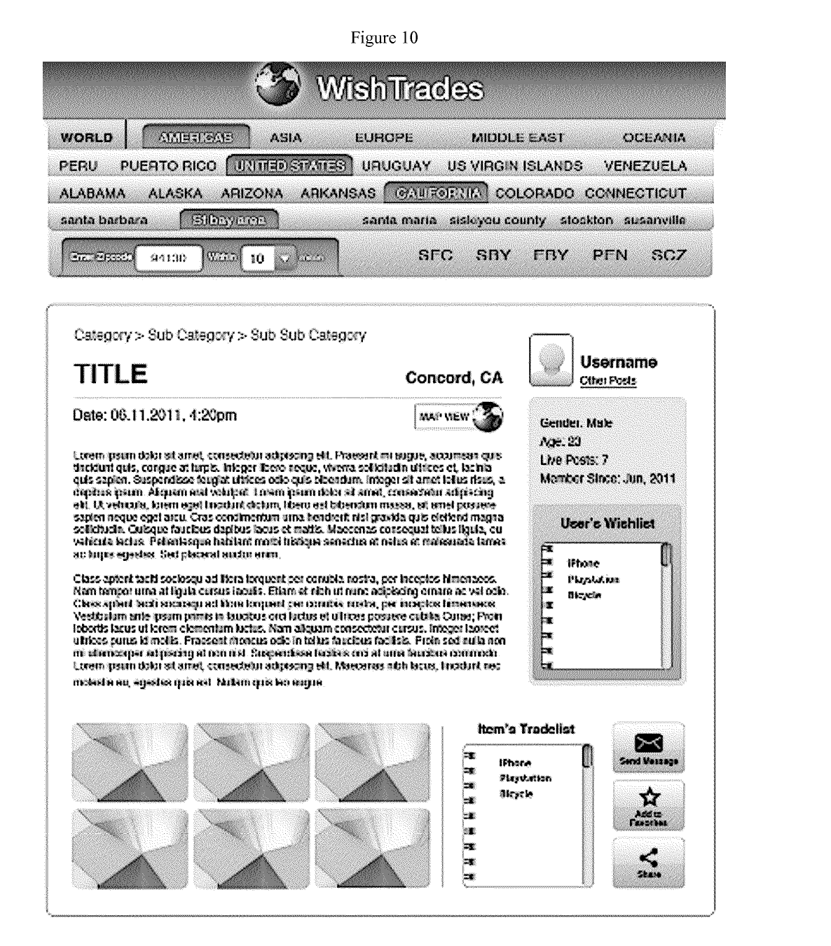

FIG. 10 shows an item description page.

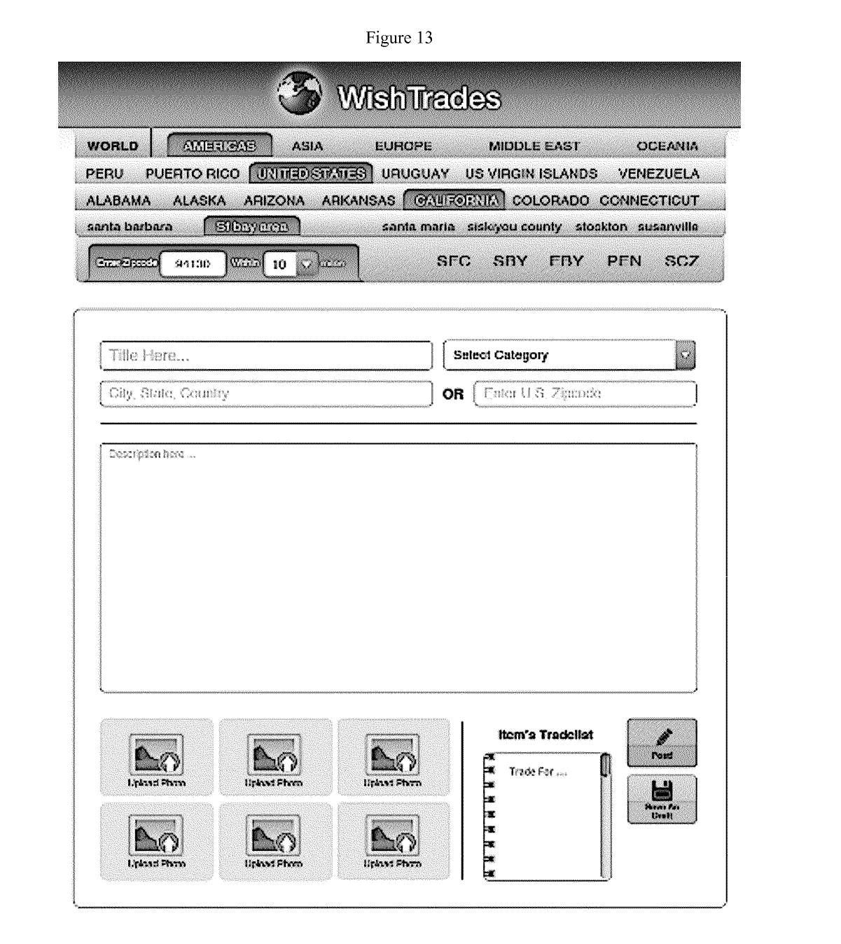

Although at times, users may simply wish to start searching by entering in a wanted item directly into the system, without having to entering in any additional search information (i.e. a search such as a direct FIG. 3 (106) to FIG. 3 (112) search); often users will want to optimize their trade better than this. The system allows for greater trade optimization by allowing users to enter in additional information about the item that they wish to trade. This can include a description of the tradelist (200), (202), (204) containing a list of items that the user would consider trading for that particular item. This data entry process is shown in more detail in FIG. 13. FIG. 10 shows what this (entered using the interface shown in FIG. 13) may look like from the perspective of other users.

Thus a user coming across this particular item on the system (i.e. after a search) will often see this item presented in a context that includes information about the poster (which often can have social network links), the item location, information on that particular item's tradelist, and even what the wishlist is for the owner of this item. This wishlist can serve as an important source of information as to what alternative trades might be acceptable to the owner of the item.

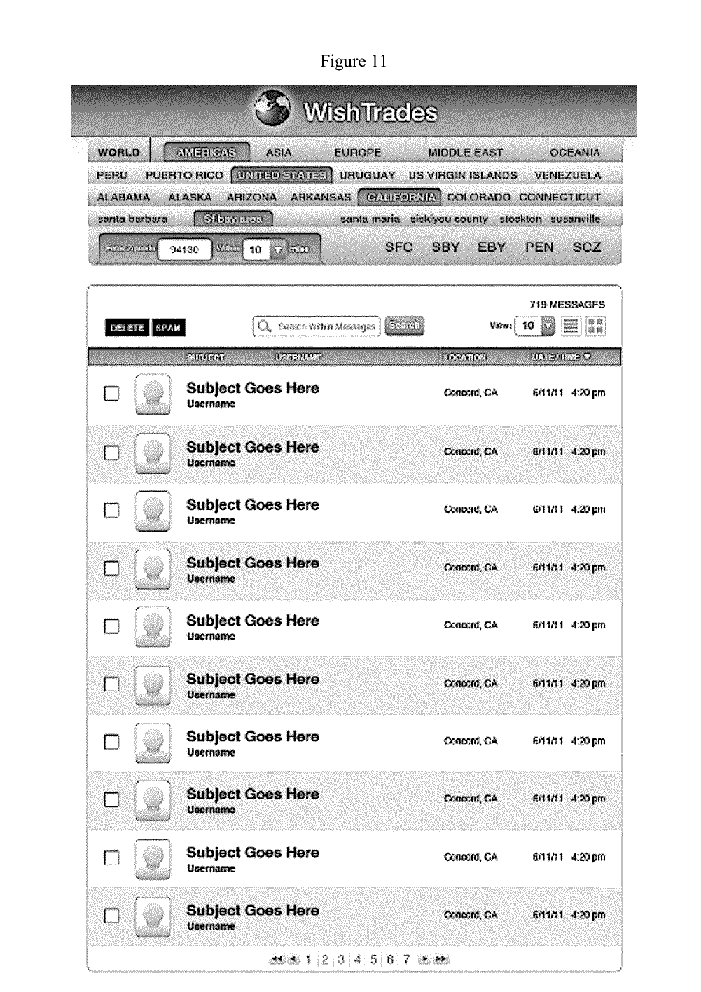

FIG. 11 shows a messages page. Here users that were mutually put in touch by the invention may communicate back and forth.

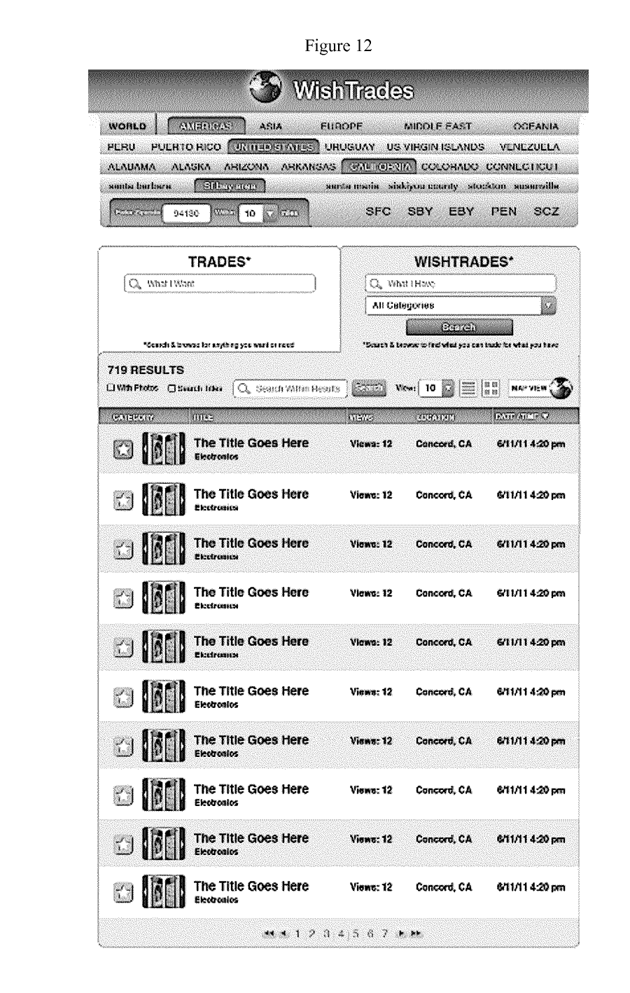

FIG. 12 shows a posts page.

FIG. 13 shows a page for creating a new posting, which was also discussed previously. The users may use pages similar to this to enter in information about their particular postings (e.g. 104, 112, and 114) and to also enter in the specific tradelists associated with these particular postings (200, 202, and 204). In the example shown in FIG. 13, the posting is not filled out yet, and the tradelist for this particular posting is also left blank.

FIG. 14 shows a new user registration page. Here new users can enter in their user identification information, which can include contact information, location, photos and also user linked information such as the optional user wishlist (616) (not shown here).

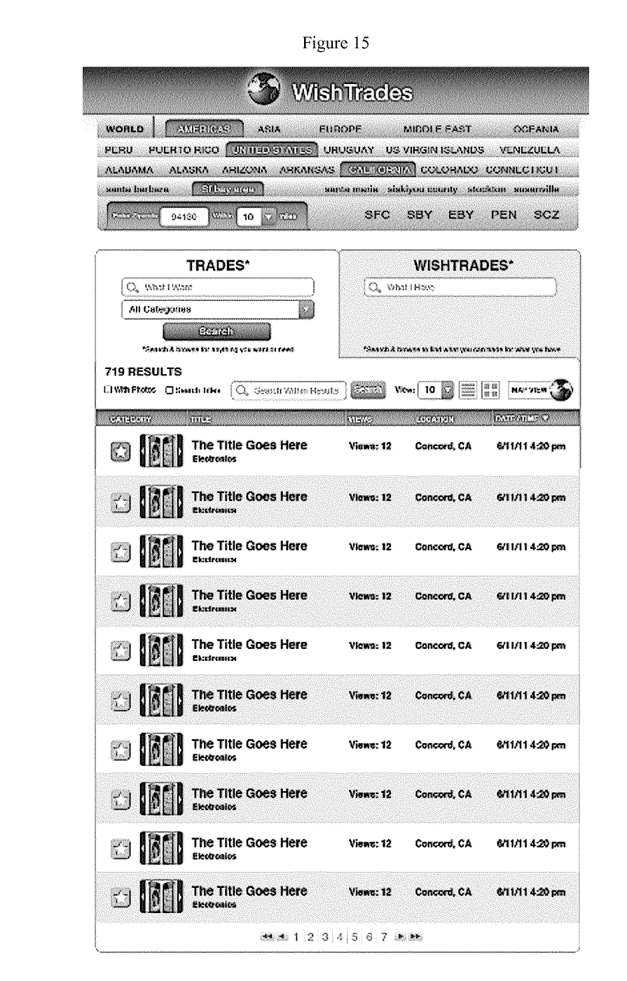

FIG. 15 shows a searching for possible trades result page.

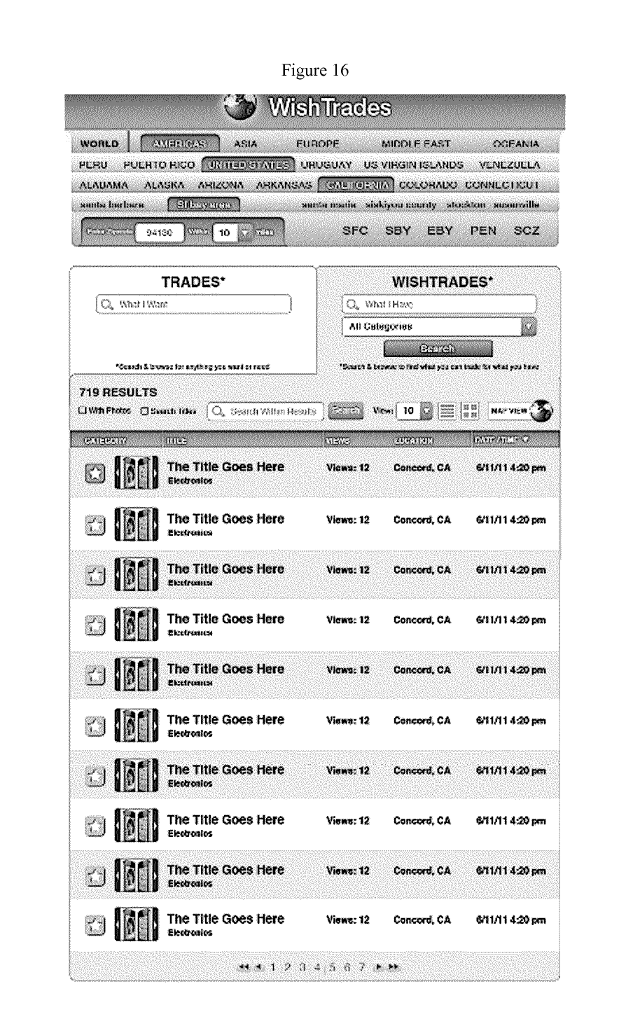

FIG. 16 shows a search for possible wishtrades result page.

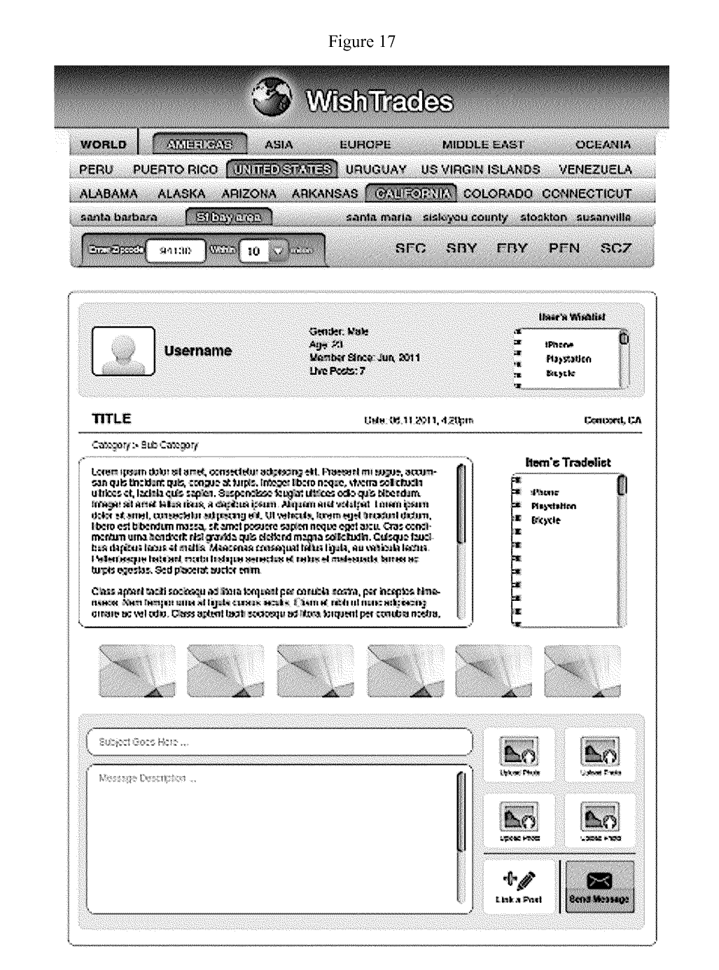

FIG. 17 shows a sending messages page.

Thus, to summarize, in some embodiments, the invention may operate as a new type of internet (often web-based) ecommerce reverse trading method. Here, instead of entering in a list of items or services that a user wishes to obtain, the user enters in a list of items or services that the user has. The system automatically matches up this list of items that the user has with a list of items wanted by other users, and automatically generates a list of possible trades. To improve reliability, the system can give more weight to users that are closer each other locally. The system can also link to one or more social networks, and give more weight to recommending potential trades between users with a higher degree of social connectivity. The system can also automatically conduct searches for items and/or services that are linked to the individual user, rather than to the user's particular set of trade items, and automatically inform the user of matches of interest by email, SMS, or other methods. The system may also perform more conventional direct trade transactions as well

### Multiple Party Transactions:

In some embodiments, the system may work to conduct multiple barter transactions between multiple users, subject to constraints such as the maximum geographic distance between the various users and/or a maximum number of transactions.

In other embodiments, users may also offer a sum of money to facilitate transactions. Thus for example the system may implement a mixed money+barter set of deals, in which the scope of the number of potential barter deals can be increased by also offering at least limited amounts of money to help facilitate the transaction. Here, for example, if neither the item nor the money alone would enable the barter transaction to proceed, the combination of barter with limited sums of money may be sufficient to enable the deal to be made.

1. A method of facilitating the trading of a first possessed set of goods and/or services for a second wanted set of goods and/or services, said method comprising:
creating a plurality of computer database listings for a plurality of users, said computer data base linked to a an internet server or web server, each said computer database listing comprising a user identification field, a possessed field that describes a possessed set of goods and/or services belonging to said user, as well as one or more additional wanted fields that describe an additional set of wanted goods and/or services not belonging to said user that the user will willingly exchange for said possessed set of goods and/or services;
using at least one web browser or mobile app on a computerized device connected to said internet server or web server by a network connection to enter in a first possessed set of goods and/or services as a search criteria to search the one or more additional wanted fields that describe said additional set of wanted goods and/or services;
and returning, to said at least one web browser or mobile app, a list of at least some of the user identification fields corresponding to users with additional wanted fields that correspond to said first possessed set of goods and/or services, said returned list also comprising a second wanted list of goods and services;
and enabling said internet or other type communication between said at least some of those users that have said first possessed set of goods and/or services and those users with additional wanted fields that correspond to said first possessed set of goods and/or services.

2. The method of claim 1, wherein said computer database listing additionally comprises a list of said possessor user contact information;
wherein possessors of said first possessed set of goods and/or services may use said contact information to contact those users with additional wanted fields that correspond to said first possessed set of goods and/or services.

3. The method of claim 2, wherein said computer database listing additionally comprises a list of user geographic location;
and wherein said list is returned in a manner that gives preferences to those users with additional wanted fields that correspond to said first possessed set of goods and/or services who are closer to said possessors of said first possessed set of goods and/or services.

4. The method of claim 2, wherein said computer database listing additionally comprises a list of user preexisting social network connections; and
wherein said list is returned in a manner that gives preferences those users with additional wanted fields that correspond to said first possessed set of goods and/or services who have closer preexisting social network connections.

5. The method of claim 1, wherein said computer database additionally comprises a standing wishlist of a wanted set of goods and/or services that is directly associated with at least some of said users,
wherein said database periodically and automatically uses said wishlist as search criteria to search said database for said first possessed set of goods and services; and
wherein said database and said web server automatically transmit a list of at least some of those users with a first possessed set of goods and services that matches said standing list to the users associated with said wishlist.

6. The method of claim 5, wherein said transmitted list is an email list, an SMS list, or social network transmitted list.

7. The method of claim 1, further entering a first possessed set of goods and/or services, and receiving a second list of goods and/or services available in exchange for said first possessed set of goods and/or services.

8. The method of claim 7, further entering a first possessed set of goods and/or services, and a maximum number of transaction parties, and receiving a second list of goods and/or services available in exchange for said first possessed set of goods and/or services that are within said maximum transaction geographic distance.

9. The method of claim 7, further entering a first possessed set of goods and/or services, a maximum transaction geographic distance, and a maximum number of transaction parties, and receiving a second list of goods and/or services available in exchange for said first possessed set of goods and/or services that are within said maximum transaction geographic distance and maximum number of transaction parties.

10. A computer network system for facilitating the trading of a first possessed set of goods and/or services for a second wanted set of goods and/or services, said system comprising:
a plurality of computer database listings for a plurality of users, said computer data base linked to an internet server or web server, each said computer database listing comprising a user identification field, a possessed field that describes a possessed set of goods and/or services belonging to said user, as well as one or more additional wanted fields that describe an additional set of wanted goods and/or services not belonging to said user that the user will willingly exchange for said possessed set of goods and/or services;
at least one web browser or mobile app on a computerized device connected to said internet server or web server by a network connection said web browser or mobile app configured to allow a user to enter in a first possessed set of goods and/or services as a search criteria to search the one or more additional wanted fields that describe said additional set of wanted goods and/or services;
said internet server or web server further configured to return, to said at least one web browser or mobile app, a list of at least some of the user identification fields corresponding to users with additional wanted fields that correspond to said first possessed set of goods and/or services, said returned list also comprising a second wanted list of goods and services;
Said internet server or web server further configured to enable internet or other type communication between said at least some of those users that have said first possessed set of goods and/or services and those users with additional wanted fields that correspond to said first possessed set of goods and/or services.

11. The computer network system of claim 10, wherein said computer database listing additionally comprises a list of said possessor user contact information;
said internet server or web server and database further configured to enable possessors of said first possessed set of goods and/or services to use said contact information to contact those users with additional wanted fields that correspond to said first possessed set of goods and/or services.

12. The computer network system of claim 11, wherein said computer database listing additionally comprises a list of user geographic locations;
and wherein said internet server or web server is configured to return said list is returned in a manner that gives preferences to those users with additional wanted fields that correspond to said first possessed set of goods and/or services who are closer to said possessors of said first possessed set of goods and/or services.

13. The computer network system of claim 11, wherein said computer database listing additionally comprises a list of user preexisting social network connections;
and wherein said internet server or web server is configured to return said list in a manner that gives preferences those users with additional wanted fields that correspond to said first possessed set of goods and/or services who have closer preexisting social network connections.

14. The computer network system of claim 10, wherein said computer database additionally comprises a standing wishlist of a wanted set of goods and/or services that is directly associated with at least some of said users,
and wherein internet server or web server and said database are further configured to periodically and automatically use said wishlist as search criteria to search said database for said first possessed set of goods and services;
and wherein said database and said internet server or web server are further configured to automatically transmit a list of at least some of those users with a first possessed set of goods and services that matches said standing list to the users associated with said wishlist.

15. The computer network system of claim 14, wherein said transmitted list is an email list, an SMS list, or social network transmitted list.

16. The computer network system of claim 10, further configured to enable a user to enter a first possessed set of goods and/or services, and configured to generate and transmit to the user a second list of goods and/or services available in exchange for said first possessed set of goods and/or services.

17. The computer network system of claim 16, further configured to enable a user to enter a first possessed set of goods and/or services, and a maximum number of transaction parties;
and further configured to generate and transmit to the user a second list of goods and/or services available in exchange for said first possessed set of goods and/or services that are within said maximum transaction geographic distance.

18. The computer network system of claim 16, further configured to enable a user to enter a first possessed set of goods and/or services, a maximum transaction geographic distance, and a maximum number of transaction parties;
and further configured to generate and transmit to the user a second list of goods and/or services available in exchange for said first possessed set of goods and/or services that are within said maximum transaction geographic distance and maximum number of transaction parties.
